(19) United States
(12) Patent Application Publication
(10) Pub. No.: US 2013/0050114 A1
(43) Pub. Date: Feb. 28, 2013

(54) DEVICE FOR CONTROLLING FUNCTIONS OF ELECTRONIC DEVICES OF A VEHICLE AND VEHICLE HAVING THE DEVICE

(71) Applicant: Fredrik BACKMAN, Frankfurt am Main (DE)

(72) Inventor: Fredrik BACKMAN, Frankfurt am Main (DE)

(73) Assignee: GM GLOBAL TECHNOLOGY OPERATIONS LLC, Detroit, MI (US)

(21) Appl. No.: 13/589,300

(22) Filed: Aug. 20, 2012

(30) Foreign Application Priority Data
Aug. 20, 2011 (DE) 10 2011 111 123.2

(51) Int. Cl. G06F 3/041; G06F 3/033

(52) U.S. Cl. 345/173; 345/156

(57) ABSTRACT

A device is provide for controlling functions of electronic devices of a vehicle having a steering device, which includes, but is not limited to a front side and a back side. The front side is directed at an occupant who is seated on a driver's seat of the vehicle, having a first input device which is designed for generating control signals, having a first display device, which is designed for the graphical representation of converted control signals in displays. The first input device is arranged on the back side of the steering device and the first display device is arranged on the front side of the steering device.

### CROSS-REFERENCE TO RELATED APPLICATION

This application claims priority to German Patent Application No. 10 2011 111 123.2, filed Aug. 20, 2011, which is incorporated herein by reference in its entirety.

### TECHNICAL FIELD

The technical field relates to a device for controlling functions of electronic devices of a vehicle and a vehicle having the device.

### BACKGROUND

Devices, with which functions of electronic devices, such as radio, air conditioner, navigation device, etc. of a vehicle can be controlled, are available in almost any vehicle. For example, such devices comprise operating elements, such as for example switches or knobs for controlling the electronic devices. Operating elements, which have a touch-sensitive sensor surface and are arranged for example on a steering wheel front, are also already known.

For example, the utility model publication DE 200 20 227 U1 comprises a vehicle steering wheel with an electronic device. The electronic device comprises a touchpad for controlling vehicle functions in the vehicle arranged on the front of a steering wheel spoke or on a steering wheel rim. On touching the touchpad, an electronic signal is generated, which is converted into graphic displays through a computer unit. The graphic displays can be displayed on a display device. The display device can project the graphic display onto a windshield of the vehicle. Alternatively, the touchpad is designed as a touch screen, via the sensor surface of which the signal generation and the displays are carried out.

In view of the foregoing, at least one object is to provide a functionally improved device for controlling functions of electronic devices of a vehicle. In addition, other objects, desirable features and characteristics will become apparent from the subsequent summary and detailed description, and the appended claims, taken in conjunction with the accompanying drawings and this background.

### SUMMARY

A device is proposed, which is designed for controlling functions of electronic devices of a vehicle, in particular of a passenger car, truck (commercial vehicle) or bus. Preferentially, the electronic devices are embodied as electronic devices of the vehicle, for example as radio, navigation system and/or air conditioner. It is particularly preferred that the electronic devices are embodied as a communication system, in particular as an e-mail device, chatting device and/or mobile radio device.

The functions of the electronic devices for example comprise a volume control in the case of the radio, a temperature adjustment in the case of the air conditioner and a distance covered display in the case of the navigation system. The functions of the communication system in particular comprise an oral or written communication with other persons.

The device comprises a steering device, which is preferentially embodied as a steering lever or a steering wheel. In the embodiment as steering wheel, the steering device comprises a steering wheel rim, at least one steering wheel spoke and a centrally arranged impact pot. The steering wheel comprises a front side and a back side, wherein the front side is directed at an occupant who is seated on a driver's seat of the vehicle. The back side of the steering device is directed opposite to the front side and in particular at a dash board of the vehicle. The device comprises a first input device, which is embodied for generating control signals. Preferentially, the first input device is embodied as a haptic input device, which the occupant has to manually touch in order to generate the control signals. In particular, the occupant can control the functions of the electronic devices by touching an operating surface of the first input device.

In an embodiment, the device comprises a computer device or the device is connected to the computer device. In particular, the computer device is embodied in order to process the generated control signals, and convert these into displays. To graphically reproduce the converted control signals in the displays, the device comprises a first display device. Preferentially, the first display device is embodied as an electronic display device, in particular as a display. For example, the displays are carried out as symbols, images and/or character, for example as letters and/or numbers.

The first input device is arranged on the back side of the steering device and the first display device is arranged on the front side of the steering device. Preferentially, the first input device is arranged on the back side of the steering device so that the occupant while travelling in the vehicle need not take his hands off the steering device in order to operate the first input device. The first display device is arranged clearly visibly on the front side of the steering device, in particular also during the trip.

The first display device is arranged in the field of vision of the occupant, so that said occupant does not have to substantially avert his view from the events on the road. At the same time, the first input device is also easily reachable for the occupant even during a steering operation of the occupant, so that he does not have to take the hands off the steering device in order to operate the input device. Accordingly, the functions of the electronic devices can be comfortably activated through the occupant. Furthermore, it can be ensured in an advantageous manner, that the occupant during the generation of the control signals via the first input device and during the detecting of the displays via the first display device, is not distracted from the road traffic, as a result of which accidents can be avoided.

In another embodiment, the first input device and the first display device are arranged on the steering device located opposite and overlapping each other in terms of surface area. In particular, the first input device and the first display device overlap each other in terms of surface area along a protection line, which is formed by a steering axle of the steering device, in particular of the steering wheel. However, it is particularly preferred that the first input device and the first display device are arranged located opposite and congruently to each other, in particular along the projection line. It is also possible that the first display device and the first input device are arranged opposite in an offset manner, in particular that the first input device and display device do not overlap with respect to surface areas.

Another embodiment provides that a size and/or outer contour of the operating surface of the input device is/are similar, equal and/or corresponding to a display area of the display device. Preferentially, the user surface and the display surface have a maximum size of up to approximately 10,000 mm², in particular approximately 5,000 mm², specifically approximately 2,500 mm² Because of the small size, the first display device and input device can be arranged without problem on the top side and bottom side of the steering device, in particular on the top side and bottom side of the first steering wheel spoke.

Optionally, the first display device and/or operating device have a quadrangular, in particular rectangular or square outer contour. Oval or circular outer contours are also possible. In another embodiment, the first input device are arranged on the back side of a first steering wheel spoke and the first display device on the front side of the first steering wheel spoke if the steering device is embodied as the steering wheel. Preferentially, the first input device is arranged adjacent and/or close to the steering wheel rim on the steering wheel spoke. Thus, the occupant can touch and operate the operating device without problem with a finger, in particular with an index finger when he has arranged his wheels on the steering wheel rim for steering.

Another embodiment provides that the first input device comprises a touch-sensitive sensor surface. Preferentially, the operating surface is designed as the touch-sensitive sensor surface. In particular, the first input device is designed as a touch field, specifically as a so-called touchpad. Optionally, the touch field is embodied as a capacitive touchpad, which can be operated through a contacting touch of the finger. In particular, the capacitive touchpad makes possible a haptic re-coupling to the occupant, so that the occupant can intuitively perform and better retrace his inputs.

In another embodiment, the first display device is embodied as a liquid crystal display, in particular as a so-called LC-display. It is also possible that the first display device is designed as an active matrix display, a so-called TFT. Optionally, the first display device is designed as a micro display. Another embodiment provides that the first input device and the first display device together form a first user interface. Preferentially, the first user interface has an appearance of a first touch screen that can be operated on a back side. In that the first input device and the first display device are arranged on the steering device preferentially located opposite and overlapping each other in terms of surface area or even located opposite and congruently to each other, the first user interface offers the appearance that the occupant on touching the sensor surface on the back side of the steering device directly and immediately operates the display area of the first display device, such as is the case with a touchpad.

Through the appearance of the first user interface, as a touchpad that can be operated on the back side an intuitive control and operation of the functions of the electronic devices through the occupant is possible. It is preferred that the displays that appear on the first display device are designed as symbols. The symbols preferentially symbolize the electronic devices that can be operated, such as for example the e-mail device, chatting and/or mobile radio device. Optionally, the symbol for the e-mail device can show an envelope, for the mobile radio device a telephone receiver and for the navigation system a roadmap. In particular, the occupant can activate the electronic device by selecting the corresponding symbol.

Alternatively or optionally in addition, the displays are designed as characters, for example as letters of a selection of letters and/or as numbers of a selection of numbers. By selecting a plurality of letters one after the other, an e-mail message or chat message can be written for example or a target address for the navigation system, input. By selecting a series of numbers, the occupant can enter a telephone number in particular. It is also possible that the displays are designed as function commands. By selecting one of the function commands, the occupant can for example send the written e-mail, call the entered telephone number or delete all inputs.

Preferentially, the occupant can select from among the displays and in particular, scroll through these. For selecting from among displays arranged next to one another, the occupant strokes over the sensor surface of the first input device with his finger from one side to the other. If the displays are arranged below one another, he strokes over the sensor surface from the top down or vice versa. A circular or complex contacting of the sensor surface is also possible in order for example to displace, enlarge or reduce in size a displayed roadmap of the navigation system.

The occupant preferentially performs the selection of the selected display by tipping onto the sensor surface once, twice or multiple times. It is possible that by contacting the sensor surface, the occupant sets a moveable element, for example a cursor on the display area of the first display device, guiding said cursor over the display area through the movements on the sensor surface. Thus, the displays through which the occupant scrolls and which he selects are more easily detectable by the occupant.

In another embodiment, the device comprises a second input device and a second display device. The second input device is likewise arranged on the back side of the steering device and the second display device on the front side of the steering device. Preferentially, the second user interface is arranged on a second steering wheel spoke of the steering wheel. It is particularly preferred that the second user interface is designed identical in construction and/or function to the first user interface. Thus, the second input device preferentially also comprises a touch-sensitive sensor surface, which is designed for operation with a finger, preferentially the index finger of a second hand of the occupant. Optionally, the second display device is designed alternatively or additionally for the graphic reproduction of the displays. In particular, the second input device and the second display device form a second user interface, which likewise has the appearance of a second touch screen that can be operated on the back side. Optionally, the first user interface and second user interface are arranged symmetrically to a symmetry axis, which divides the steering device in the middle. Through the symmetry of the first and second user interface, these can be more easily operated by the occupant with both hands.

In a preferred embodiment, the device comprises a third display device that is designed to alternatively or optionally in addition to the first and/or second display device, display the displays. The third display device preferentially has a larger display area than the first and second display device. In particular, the display area of the third display device has a size of preferentially more than approximately 30,000 mm², in particular more than approximately 20,000 mm², especially more than approximately 10,000 mm².

In another embodiment, the third display device is designed as a liquid crystal display, in particular as an LC-display or a TFT-display. Preferentially, the third display device is arranged in a dashboard, an instrument panel or a center console of the vehicle. It is particularly preferred that the third display device is arranged in driving direction of the vehicle behind the steering device. For example, the third display device forms the instrument panel, on which among other things the speed and rotational speed display of the vehicle are displayed. It is preferred that the third display device is arranged on a connection between steering wheel and dashboard, in particular on a covering of a steering axle. It is preferable that the third display device displays the symbols and/or function commands in a selection menu from which the occupant can select. The selection is preferentially made via the first and/or second operating device.

Alternatively or optionally in addition, the third display device is designed in order to present as continuous text, number sequence or as alphanumerical character sequence the characters selected and displayed via the first and/or second user interface. Preferentially, the third display device displays the characters as complete text. Thus, the occupant can check if he has made the correct selection.

In another embodiment, one of the two user interfaces is designed for selecting the electronic device and displaying the corresponding symbol. Preferentially, the other user interface is designed in particular simultaneously to the selection and display of the individual characters, in particular of the letters and/or numbers.

### BRIEF DESCRIPTION OF THE DRAWINGS

The present invention will hereinafter be described in conjunction with the following drawing figures, wherein like numerals denote like elements, and:

FIG. 1 is a top view of a device for controlling electronic functions which are arranged in the region of a steering device of a vehicle;

FIG. 2 is a perspective top view of a back side of the steering device from FIG. 1;

FIG. 3 is a sectional view of the steering device and device of the FIG. 1 along the section line A-A;

FIG. 4 is another perspective top view of the back side of the steering device from FIG. 1;

FIG. 5 is a top view of an alternative to the device from FIG. 1;

FIG. 6 is an alternative top view of the device from FIG. 1;

FIG. 7 is a modified top view of the device from FIG. 1;

FIG. 8 is an alternative perspective top view of the back side of the steering device from FIG. 1;

FIG. 9 is an alternative top view of the device from FIG. 1; and

FIG. 10 is a further perspective top view of the back side of the steering device from FIG. 1.

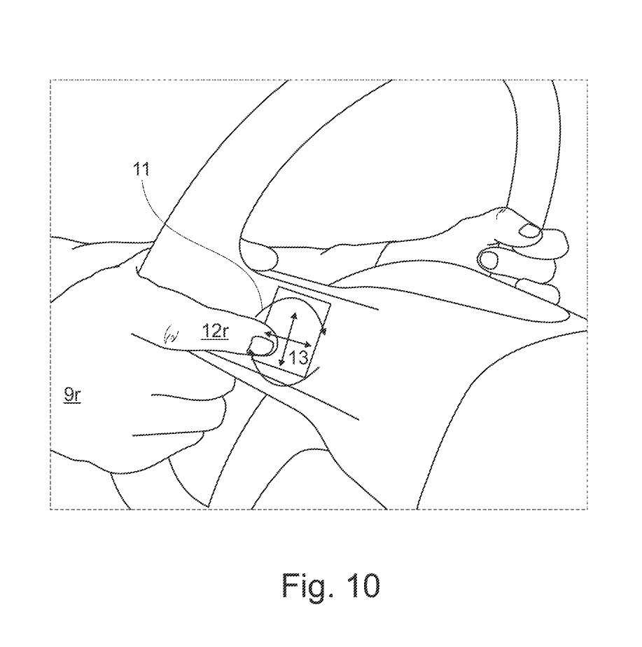

### DETAILED DESCRIPTION

The following detailed description is merely exemplary in nature and is not intended to application and uses. Furthermore, there is no intention to be bound by any theory presented in the preceding background or summary or the following detailed description.

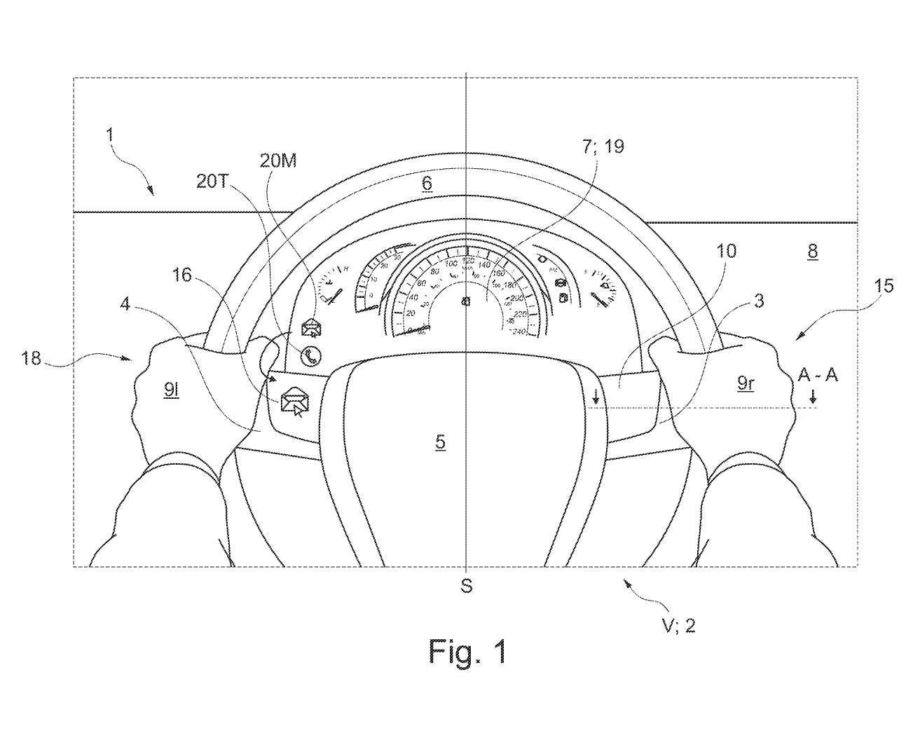

FIG. 1 shows a top view of a device 1, which is designed for controlling functions of electronic devices of a vehicle, e.g., of a passenger car, of a truck or of a bus. The electronic devices are for example a car radio, an air conditioner, a navigation system, an e-mail system and/or chat-system, a mobile radio system, etc. The electronic functions comprise functions of the radio, such as for example a volume control, functions of the air conditioner, such as for example a temperature adjustment, functions of the navigation system, such as for example a roadmap display, functions of the e-mail system or chat-system, such as for example generating, sending and receiving e-mails or chats, functions of the mobile radio system, such as for example a number input, establishment and reception of telephone calls, etc.

The device 1 is arranged in the region of a steering wheel 2 of the vehicle. The steering wheel 2 is designed as a steering wheel 2. The steering wheel 2 comprises a first and a second steering wheel spoke 3; 4, which connect a centrally arranged impact pot 5 of the steering wheel with a steering wheel rim 6. In FIG. 1, the steering wheel 2 is shown in a top view of a front side V of the steering wheel 2. The front side V is directed at an occupant who is seated on a driver's seat of the vehicle which is not shown, in order to steer the vehicle with the steering wheel 2.

Behind the steering wheel 2 an instrument panel 7 is arranged in a dashboard 8 of the vehicle, at which the occupant can look between the steering wheel rim 6 and the impact pot 5. On the instrument panel 7, a speed and rotational speed display are arranged among others. A right hand 9r of the occupant grips about the steering wheel rim 6 at the height of the first steering wheel spoke 3 and a left hand 9l at the height of the second steering wheel spoke 4. The device 1 comprises a first display device 10, which is arranged on the front side V of the first steering wheel spoke 3. It comprises a substantially rectangular outer contour and a size of approximately 2,500 mm². The first display device 10 is designed as a liquid crystal display, in particular as an LC-display or as a TFT-display.

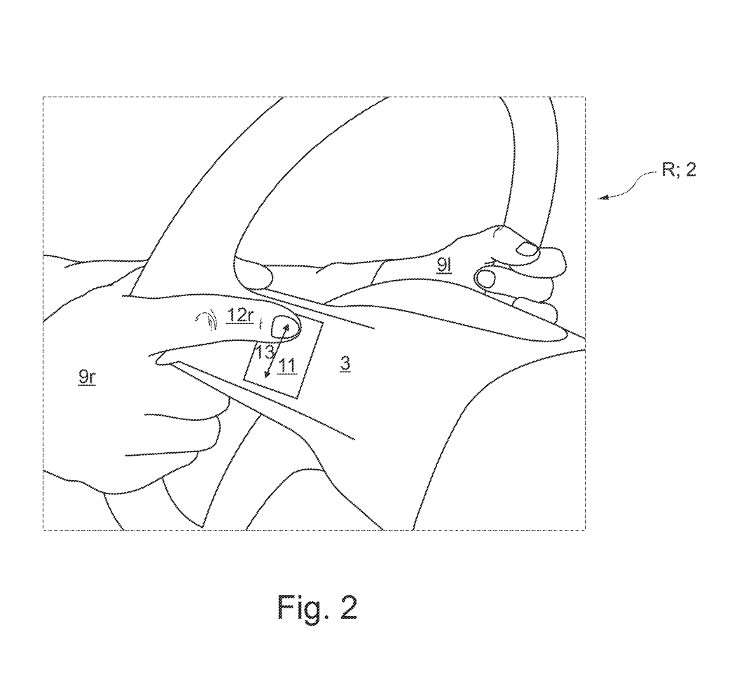

FIG. 2 shows a perspective view of a back side R of the steering wheel 2; in particular of the back side R of the first steering wheel spoke 3. The back side R is located opposite the front side V and is directed at the instrument panel 7 (FIG. 1). The device 1 comprises a first input device 11, which is arranged on the back side R of the first steering wheel spoke 3. The first input device 11 comprises a rectangular sensor surface of approximately 2,500 mm². The sensor surface is designed in order to detect touches. Thus, the first input device 11 is designed as a touch field, in particular as a so-called touchpad. The first input device 11 is arranged on the back side R of the first steering wheel spoke 3 in such a manner that it can be operated with a finger 12, in particular the index finger of the right hand 9r without the occupant having to take said hand off the steering wheel. Thus, the occupant can control or steer the vehicle and operate the first input device 11 at the same time.

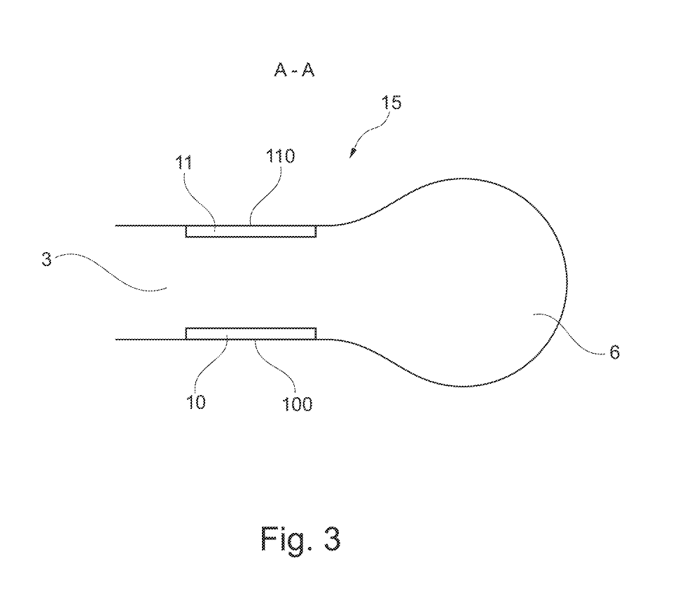

FIG. 3 shows a sectional view through the first steering wheel spoke 3 along the section line A-A from FIG. 1. The first input device 11 and the first display device 10 are arranged on the steering wheel spoke 3 located opposite and congruent to each other. Here, the first input device 11 and display device 10 have an almost identical or similar size and/or outer contour. The first display device 10 is integrated in the steering wheel spoke 3 in a recess manner. Towards the front side V it is protected from damage through a transparent covering layer 100, e.g., of plastic.

The first display device 10 and the first input device 11 together form a first user interface 15, via which the occupant can perform function adjustments on the electronic devices of the vehicle. Here, the occupant moves his finger 12 over the sensor surface of the first input device 11 and/or tips onto these once, twice or multiple times in order to generate control signals 13 for implementing the functions.

A processing device of the device 1 which is not shown graphically converts the control signals 13. The graphical representation of the converted control signals 13 is effected via displays 14 on the first display device 10. Here, the displays 13 are displayed on the first display device 10 simultaneously with the touching of the sensor surface of the first input device 11.

In that the first display device 10 and the first input device 11 are arranged located opposite and in particular congruently and in addition still have a same or similar size and/or outer contour, the first user interface 15 has the appearance of a first touch screen that can be operated on the back side. In particular, the first user interface 15 gives the impression that it is designed as an individual component that extends from the back side R as far as to the front side V of the steering wheel spoke 3 and on which control signals 13 can be simultaneously input and on which displays 14 corresponding to the converted control signals 13 are graphically reproduced. According to FIG. 1, the device 1 comprises a second display device 16 which is arranged on the front side V of the second steering wheel spoke 4.

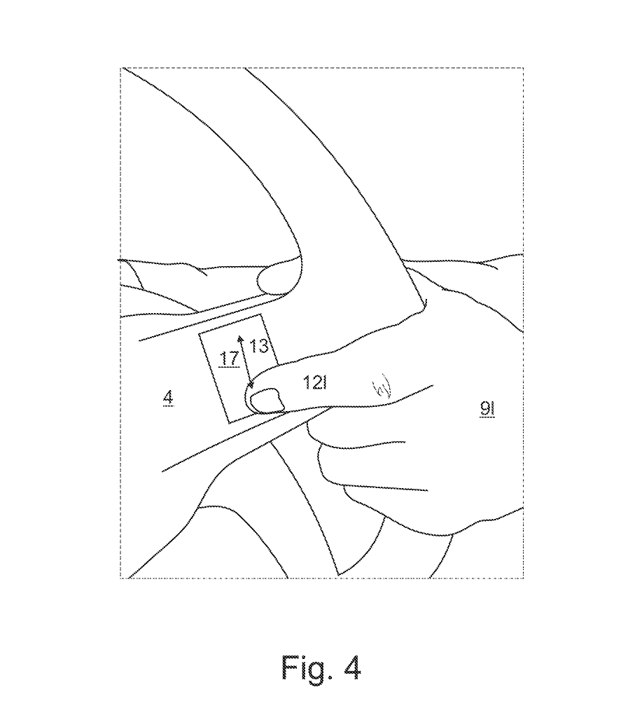

In FIG. 4, a perspective view of the back side R of the second steering wheel spoke 4 is shown. The device 1 comprises a second input device 17, which is arranged on the back side of the second steering wheel spoke 4. Together, the second input device 17 and the second display device 16 form a second user interface 18. The second user interface 18 is designed identical in construction and/or function to the first user interface 15. In particular, the second user interface 18 is arranged and/or designed in mirror image to a symmetry axis S running perpendicularly through a steering wheel hub. The second user interface 18 also has the appearance of a touch screen that can be operated on the back side.

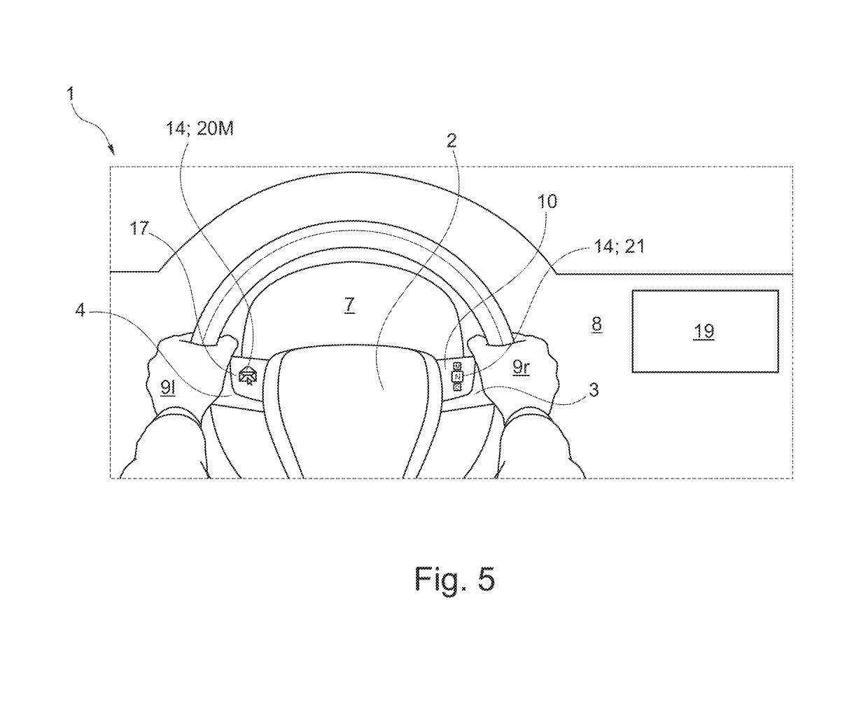

According to FIG. 1, the device comprises a third display device 19, which, as shown in FIG. 1, is integrated in the instrument panel 7. Alternatively, the third display device 19 is arranged spaced from the instrument panel 7 in the dashboard 8 or in a center console of the vehicle, as is shown in FIG. 5. The third display device 19 is likewise designed as a liquid crystal monitor, in particular an LC-display or TFT-display.

When the third display device 19 according to FIG. 1 is integrated in the instrument panel 7, the speed and rotational speed display, etc. are displayed via the liquid crystal monitor of the third display device 19. In addition, the third display device 19 shows a selection menu for the selectable electronic devices. These are shown through symbols 20M; 20T arranged among one another on the third display device 19. A first symbol (envelope) 20M points to an e-mail system, a second symbol (telephone receiver) 20T to a mobile radio system.

In FIG. 4 it is shown that the occupant, through a touching stroking movement of the finger 121 directed from the top down or vice versa on the sensor surface of the second input device 17 can select between the electronic devices listed one below the other on the third display device 19. By double tipping onto the sensor surface of the second input device 17, the occupant selects the desired function. According to FIG. 1, the selected function is the e-mail system. The symbol 20M reflecting the e-mail system appears on the second display device 16 on or after the selection by the occupant.

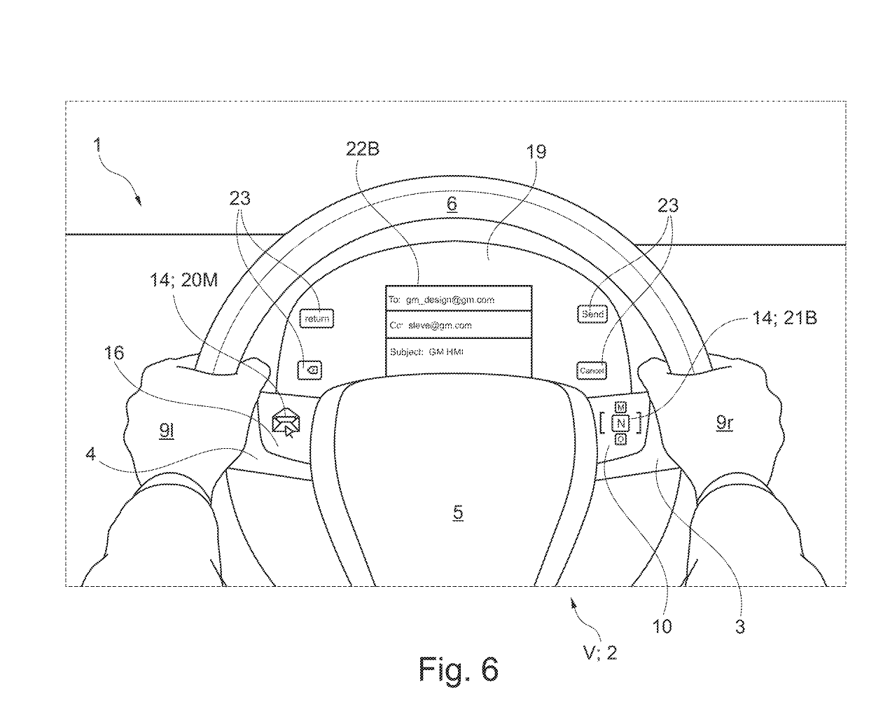

FIG. 5 to FIG. 8 shows the steering wheel 2 in a top view of the front side. With the device 1 shown there, different functions of the electronic devices are activated. As is shown in FIG. 6, following the selection of the e-mail function, letters 21b of a letter selection listed one below the other are displayed on the first display device 10 in the sequence of the alphabet, which letters can be used for generating an e-mail or a chat text.

When the occupant has alternatively selected for example the mobile radio system, the corresponding symbol 20T, as shown in FIG. 6, appears on the second display device 16. In order to enter a telephone number, numbers 21N of a number selection from 0-9 are displayed on the first display device. Writing a sms is also possible since each displayed number 21N is assigned the typical characters as they are known for example from popular mobile telephones.

According to FIG. 2, the occupant can scroll through the letter or number selection by stroking with the finger 12r of the right hand 9r up or down the sensor surface of the first input device 11 in a touching manner Through the double tipping onto the sensor surface, the occupant selects in succession the desired characters 21B or the desired number 21N in order to generate the e-mail or the telephone number.

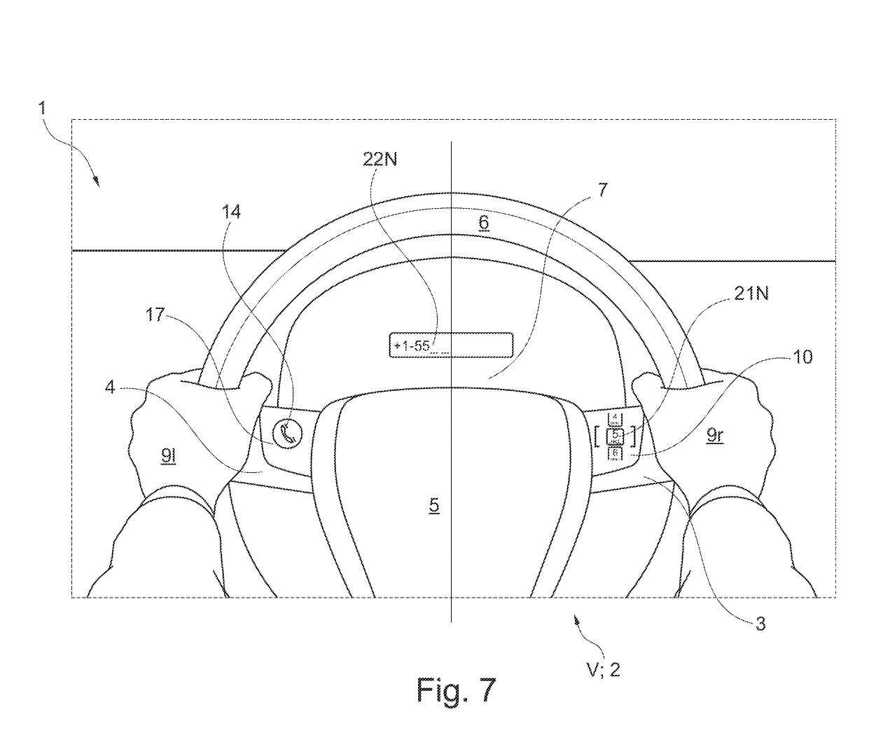

According to the FIGS. 6 and 7, the third display device 19 shows the selected characters 21B or numbers 21N as text, character sequence, number sequence or alphanumerical sequence 22B; 22N. The speed or rotational speed display etc. is briefly hidden if the third display device is integrated in the instrument panel 7. On the third display device, function commands 23 are also displayed. According to FIG. 6, these function commands 23 are for example a deleting function, a sending function, a cancelling function etc. of the written e-mail.

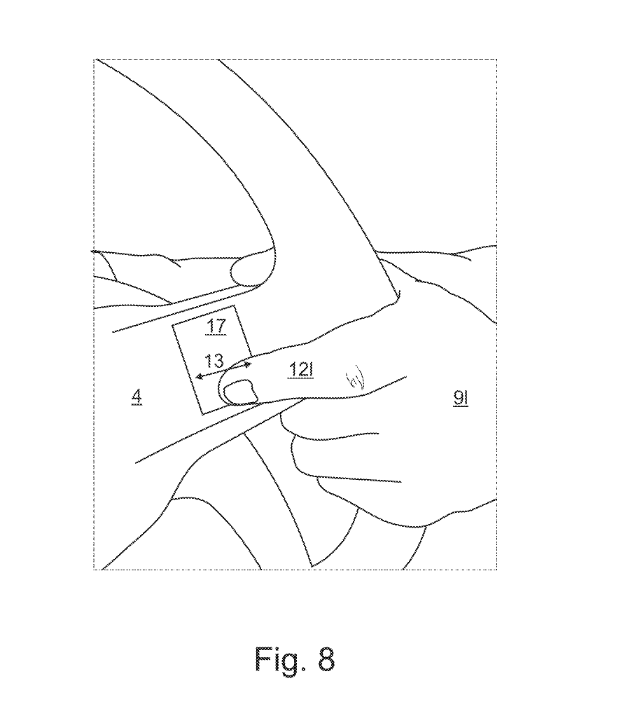

The occupant can select from among the function commands 23 through a touching upward or downward movement (according to FIG. 4) or lateral movement (according to FIG. 8) of the finger 121 of the left hand 91 and select the desired function command 23 through the double tipping onto the sensor surface of the second input device 17. When he selects for example the function command 23 “send”, the written e-mail is sent to the recipient.

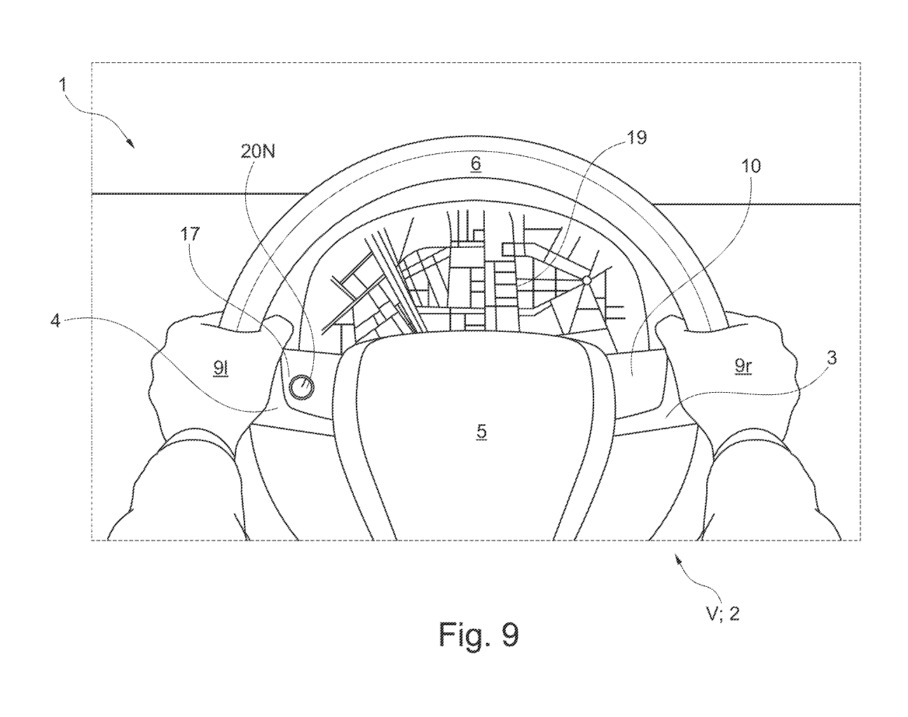

In FIG. 9, the device 1 is used for controlling functions of the navigation system of the vehicle. After the selection of the navigation system via the symbol 20N on the third display device 19 (similar to that shown in FIG. 1) it appears on the second display device 16. It is possible for example to enter a target address via the first input device 11. This is carried out similar to that shown and described in FIGS. 2 and 5, by selecting characters 21B and/or numbers 21 from the character selection and/or number selection. In FIG. 9 it is shown that the third display device 19 displays a roadmap. The occupant can displace or adapt the map by moving the finger 12r of the right hand 9r in a touching, circular manner on the sensor surface of the first input device 11.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A device for controlling functions of electronic devices of a vehicle, comprising:
a steering device comprising a front side and a back side and the front side is directed at an occupant who is seated on a driver seat of the vehicle;
a first input device that is configured to generate control signals is arranged and on the back side of the steering device; and
a first display device that is configured to graphically display converted the control signals and arranged on the front side of the steering device.

2. The device according to claim 1, wherein the first input device and the first display device are arranged on the steering device located opposite and in terms of area overlap each other.

3. The device according to claim 1, wherein the first input device and the first display device are arranged on the steering device located opposite and arranged located opposite and congruently to each other.

4. The device according to claim 1,
wherein the steering device comprises a first steering wheel spoke,
wherein the first input device is arranged on the back side of the first steering wheel spoke and the first display device is arranged on the front side of the first steering wheel spoke.

5. The device according to claim 1, wherein the first input device is configured for operation with a finger.

6. The device according to claim 1, wherein the first input device comprises a touch-sensitive sensor surface and is further configured as a touch field.

7. The device according to claim 1, wherein the first display device is a liquid crystal display.

8. The device according to claim 1, wherein the first input device and the first display device are configure to form a user interface that has an appearance of a first touch screen operable on the back side.

9. The device according to claim 1, wherein the first display device and a second display device are designed as symbols.

10. The device according to claim 1, further comprising a second input device and a second display device,
wherein the second input device is arranged on the back side of the steering device and the second display device is arranged on the front side of the steering device.

11. The device according to claim 10, wherein the second input device and the second display device are configured to form a second user interface having an appearance of a second touch screen operable on the back side.

12. The device according to claim 11, wherein the second user interface has a substantially similar construction to a first user interface.

13. The device according to claim 9, further comprising a third display device that is configured to display the symbols in a selection menu,
wherein the displays of the third display device can be highlighted and selected via the first or second input device.

14. The device according to claim 13, wherein the third display device is arranged in a dashboard of the vehicle.

15. The device according to claim 14, wherein the third display device is designed as a liquid crystal display.
